(19) United States
(12) Patent Application Publication
(10) Pub. No.: US 2014/0152893 A1
(43) Pub. Date: Jun. 5, 2014

(54) CREATING PRESENTATIONS BY CAPTURING THE CONTENT OF A COMPUTER GENERATED VIRTUAL SECONDARY DISPLAY

(71) Applicant: Ivo Martinik, Ostrava-Poruba (CZ)

(72) Inventor: Ivo Martinik, Ostrava-Poruba (CZ)

(21) Appl. No.: 13/705,970

(22) Filed: Dec. 5, 2012

(51) Int. Cl. G06T 1/60; H04N 5/04

(52) U.S. Cl. CPC G06T 1/60; H04N 5/04
USPC 348/515; 345/531

(57) ABSTRACT

A method whereby a second display device is simulated, on a personal computer or other electronic device having a primary display, which may not have the capability of connection to a second display device, using software so that images directed to be displayed on the second display device may be redirected by a personal computer or other electronic device to appear on the primary display device. The software may display the image in a portion of the primary display, allowing the user of the invention to monitor the simulated display and capture images from the simulated second display using an automated capture algorithm to capture and store the image for future use. The presenter or user of the method may make adjustments to the capture parameters, via a control interface which may also be viewed on the primary display device.

### BACKGROUND AND SUMMARY OF THE INVENTION

Personal computing devices are becoming more and more common. Just two examples of such devices are smart phones and tablet computers. Many more configurations of this type of device are becoming available every day and the two devices listed should not be considered a completely inclusive listing. Increasingly these types of devices are being used to perform functions that were previously done by personal computers and laptop computers. Most of these devices have a self-contained display and do not have the circuitry or connections required to support a secondary display.

A shortcoming of many personal computing devices is their inability to be connected to secondary displays. Further, even if a personal computing device may be connected to a secondary display, the connection to such a display eliminates much of the convenience associated with the connected personal computing device, robbing the user of the portability and small size that make personal computing devices so popular among their owners. If a user wishes to create a presentation using a personal computing device without a secondary display, he or she is limited to viewing the presentation in the format of the primary display of such a device. This limitation does not allow the user to view a presentation as it might later be displayed on a secondary display device during an actual presentation to an audience. The result may be a presentation that is displayed with a less than optimal selection of colors or distorted as the result of an incompatible aspect ratio. Such a result may require the presenter of the presentation to make adjustments to the presentation before it may be displayed correctly on a secondary display device.

A presenter may also find it difficult to create a presentation for later use in an environment which has secondary display devices unlike those available to the presenter at his or her normal workplace. Examples of such devices may be display projectors and television monitors that have a variety of different display aspect ratios. In order to create a presentation that is displayed correctly on such a display device, a presenter may have to create or make adjustments to a presentation after connecting a personal computing or other device to the same or similar device as may be used in a later presentation to an audience. This process is inefficient and does not allow a presenter to confidently create a presentation in advance while enjoying the convenience of a personal computing device.

A virtual secondary display may be implemented to allow a user of a personal computing device to create or modify a presentation on such a personal computing device without the need to make adjustments to the images as they are displayed at a later time on a secondary display device. The personal computing device may direct image information to such a virtual display and cause the display of such information in a second portion of the primary display. In such an implementation, a first portion of the primary display may be configured to display what would have been displayed in the entire primary display prior to the implementation of such a virtual secondary display. Using such an implementation, a user may create a presentation using software running on a personal computing device and visible on a first portion of the primary display. In such an implementation, the user may view the presentation images on a second portion of the primary display device and make adjustments to the content of the presentation while viewing the resulting images in a second portion of the primary display device.

There is little doubt that the effectiveness of instructional materials such as classroom, business and other presentations are improved with illustrations. For best effect and retention of audience interest, illustrations should be consecutive, showing incremental changes in the material displayed and perhaps most importantly, show the image with sufficient clarity for the viewer to be able to discern the information contained in the presentation.

When a presenter wishes to use a single-display personal computing device to capture these illustrations from a presentation or other source of material developed for display on a computing device with the capability of supporting a second display device, he runs into a roadblock. Even if the personal computing device implements the means to display the images of a presentation to a virtual secondary display as discussed above, the presenter may have to stop the presentation, capture the image, save it to the device memory and then start the displayed material again. Stopping, copying, saving and restarting the displayed material would undoubtedly be time consuming and prone to errors, detracting from an ultimate goal such as being able to communicate a concept to an audience using images combined with other content.

An experienced presenter will realize that it is important that illustrative images are captured frequently enough that they do not confuse a viewer. In order for a series of images to best portray the concepts presented during a presentation, those images should convey incremental images that represent a series of steps from one concept to the next. Failure to create incremental images results in a series of summary images which, while they may make good key points, do not provide the viewer with the incremental pieces of information needed to bridge the gap from one concept image to the next.

A solution to the problem of the need for high levels of user involvement required with the image capture approaches just described has been the use of a video camera to record an entire presentation. This approach allows for capture of images as they are displayed on a computer monitor or an overhead projector but would be very unwieldy when applied to a personal computing device with its relatively small screen. Even if a video camera could be configured to record the images on a personal computing device display screen, it suffers from the problem of capturing much more information than is needed, capturing hundreds or even thousands of nearly identical images. As a result of the large number of images, the video files obtained from the use of a video camera are extremely large and difficult to easily deliver to potential audiences. In the case of a personal computing device, the video files may be too large to be stored in the available memory of the device. The highly compressed video images (frames) of video files are also of much lower quality than bitmap images captured directly from a computer system.

Other methods of capturing displayed images employ external video capture devices (video grabbing cards) in conjunction with driver software to capture images from a video source. These devices are not currently available for use with personal computing devices but even if such a device were to become available, its use would require the operator to capture the entire video recording or to select small segments of a video recording and as a result, still suffer from the large file size and image quality problems present with the use of the video camera method previously described.

The present invention provides a means by which the user of a personal computing device may create a virtual display device and graphics control circuit, using software that is executed on his device. The invention allows the user of a personal computing device to cause the personal computer device to display images to the virtual display device as if it were an actual secondary display connected to the device. The invention allows the user of the invention to capture said images automatically and without continuous actions by the user. The invention allows the user of the invention to optimize the capture of said images so as to capture a sufficient number of images to allow a later viewer of the images to understand the material presented without capturing such a large number of images that the resultant image data file becomes difficult to store and transmit to other audiences.

On a computing device, a virtual secondary display is created by the use of an algorithm implemented using computer software when the display does not physically exist. The virtual display device appears to the device operating system and other programs running on the computer as if it is real. Content that the user wishes to capture can be directed to this virtual display. Capture software running on the computing device is able to display a preview of the content of such virtual display in a window on the primary display of the device in substantially the same manner (albeit smaller) that the images would appear on a full display for later presentation to a viewing audience. In this manner a presenter may assemble (for example, from stored files) and view a final presentation on a personal computing device, such as a tablet computer. Using the present invention the presenter is able to view each of the presentation images, and edit them if desired, all without having to use another display device.

Because computer display devices may be any of several types and configurations, the capture software allows the format of the virtual display to be configured to match that of an actual display device that may later be used to display a presentation. The advantage of this configurability is that a presentation may be created and captured for use on a display device to which the creator of the presentation may not have access prior to a presentation.

In a computer software embodying the principles of the invention, the problems associated with the user having to remain actively involved in the image capture process, significant gaps in information content from one image to the next, and the problems associated with managing and distributing large files are addressed by providing a method for automatically capturing full resolution static images from the virtual display of a computing device without the need for any additional hardware, detecting changes to the image and automatically storing single static images when the image has changed reasonably. This approach avoids capturing large numbers of identical images as is the case with a video camera, but allows for captures that are frequent enough so that the images captured represent a sufficiently detailed summary of the presented material as to allow the viewer to comprehend the material.

In the present implementation of the invention, the amount of generated data is optimized by a suitable algorithm. In an exemplary embodiment of the present invention, a new full resolution static image (a picture slide) is created when the following are true:

The original picture has changed appreciably (what is reasonable may be pre-set by the user); and/or,
Enough time has passed since the previous picture slide was captured (what is “enough” time may be pre-set by the user); and/or,
The picture is relatively stable (the source data has not changed very much over a predetermined period of time).

The advantages of this algorithm is that it allows the user to initiate a static image capture process using pre-set parameters and then focus on the presentation being created without having to be concerned with the mechanics of the image capture process. If the presenter or operator of the software embodying the algorithm wishes to increase or decrease the amount of detail captured, he or she may choose to adjust the parameters used by the software to determine when an image is captured and stored simply by making adjustments to these parameters from a program interface presented on the user interface of a computer or other device running the image capture software.

Further improvements may be made to implementations of the capture algorithm to improve the ease of use by implementing features such as controls that allow the operator to adjust the image capture parameters using user interface controls such as a sliding control adjustment that may simply be adjusted from more detail to less detail settings without the user having to adjust each parameter separately. Additional functions such as a view of the images being captured and indicators which display the number of images captured and total file size of the captured images may be added to further improve the operator's ability to optimize the image capture process. If the user desires to create a complete presentation, the image capture algorithm may be further combined with an interface to audio or video capture hardware to create a file that combines both an audio or audio/video recording and the images captured by the algorithm whereby the images are keyed to allow for a playback of those images displayed in synchronization to the audio or audio/video recording.

In addition to the novel features and advantages mentioned above, other benefits will be readily apparent from the following descriptions of the drawings and exemplary embodiments.

### BRIEF DESCRIPTION OF THE DRAWINGS

FIG. 1 is a block diagram of a representative illustration of a tablet computer implementing a virtual second display algorithm with an actual and virtual display.

FIG. 2 is a flow diagram of an exemplary embodiment of the logic for performing the process of creating a virtual graphics control circuit.

FIG. 3 is a flow diagram of an exemplary embodiment of the logic for performing the main steps of an image capture software program.

FIG. 4 is a flow diagram of an exemplary embodiment of the logic for performing the steps of initializing an image capture software program.

FIG. 5 is a graphical representation of an exemplary embodiment of a user interface used for an image capture program.

FIG. 6 is a graphical representation of an exemplary embodiment of a user interface used to adjust image capture parameters.

FIGS. 7A-7C are flow diagrams of an exemplary embodiment of the logic for performing the steps required of an image capture software program.

FIG. 8 is a flow diagram of an exemplary embodiment of the logic for performing the main steps of synchronizing captured images with an audio or audio/video recording.

### DETAILED DESCRIPTION OF EXEMPLARY EMBODIMENT(S)

Stored content or content otherwise received on a first personal computing device (such as a tablet computer) is captured in the form of images and virtually displayed as if on a secondary display, even though the personal computing device may not have connections for a secondary display and a secondary display is not actually present at the time. Images are captured using the process of the present invention, and displayed on the primary display of the personal computing device as they would appear on a secondary display in front of an audience. In this way, the captured images that form the completed presentation may be assembled with one personal computer display device as if a secondary display was present and showing the images at that time. The personal computer may be running the image capture program in the background of the personal computing device (and may be shown (and controlled) on one portion of the user's personal computing device display) while showing in the foreground the images that would be visible to a future audience (that may be shown on another portion of the user's personal computing device display, simultaneously with the capture program operating on the other portion of the same display). In this way the present invention may be used by a speaker or presenter to prepare and assemble a presentation while away from the office, for example while traveling, and see the output on his personal computing device without need for a secondary display. The entire presentation can thus be captured and assembled on one device for later showing to a larger audience.

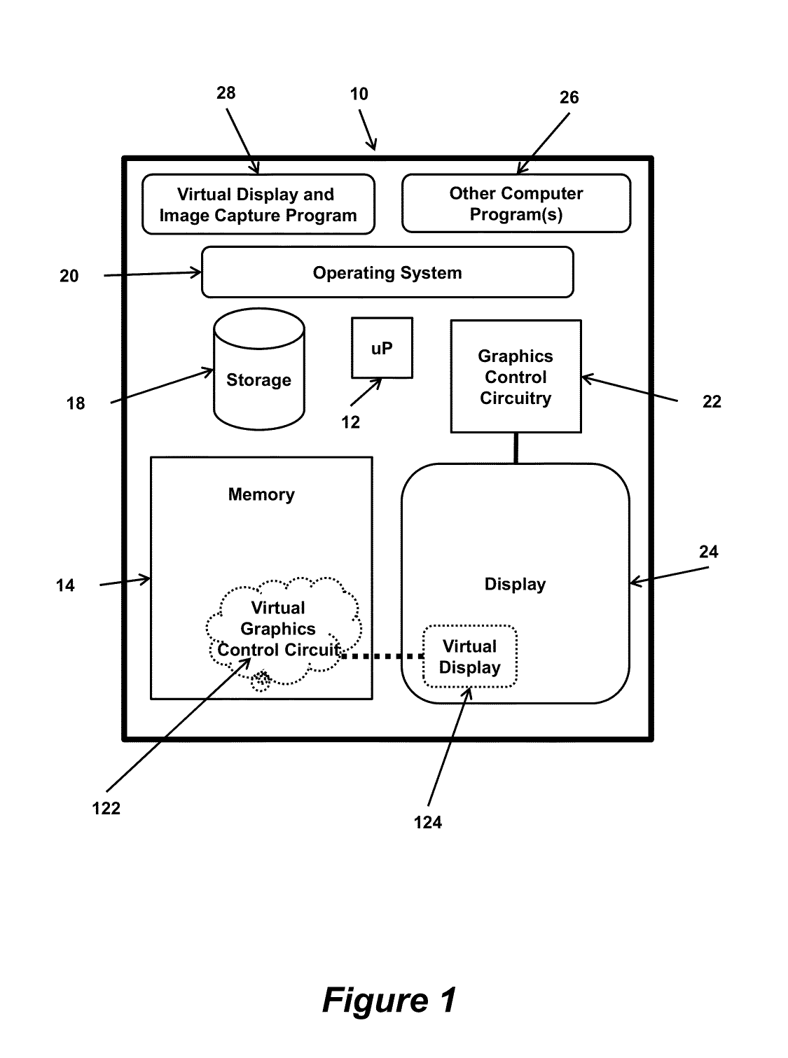

FIG. 1 is a graphical illustration showing generally a tablet computer 10, which depicts a programmatic implementation of the invention. In a preferred embodiment of the present invention, the tablet computer may comprise a processor 12, memory 14, computer storage 18, a computer operating system 20, graphics control circuitry (the graphics card) 22 that supports a display device, and a display 24. In a tablet computer system as illustrated, a virtual second display and image capture program 28, and various other computer programs 26 in addition to the computer operating system will generate images which the computer operating system 20 then directs to the graphics control circuitry 22. The graphics control circuitry further processes the image data and sends it in a manner and format such that the image will appear on the display of the tablet computer 24 or if instructed by the operating system 20, the image will be directed to a virtual graphics control circuit 122 and then to a virtual display 124 which may be created by computer software implementing the invention, and shown in a window or portion of the display 24.

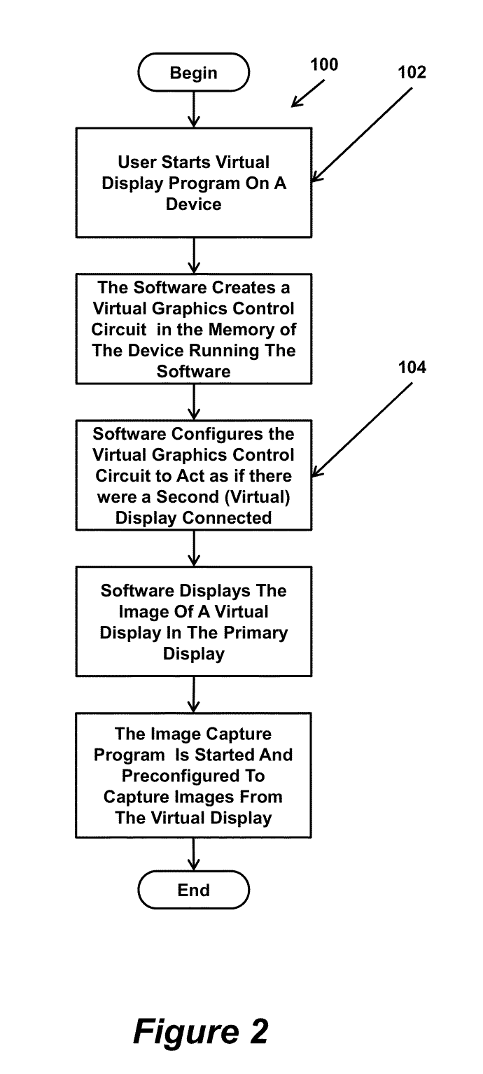

Referring to FIG. 2, which is a flow diagram of a software implementation of an exemplary embodiment of the invention 100 which causes the personal electronics device to behave as if a second display device were connected. In step 102 the user selects and starts the virtual display software. When running, the software formats a virtual graphics control circuit 122 in the memory of the device 14. The software then configures the virtual graphics control circuitry to act as if there were a second display connected to the device 104. The image capture software may also send control commands to the virtual graphics control circuitry 122 to configure the control circuitry to act as if the virtual display 124 were of a type and format of monitor preselected by the user. Such a control command results in images sent to the virtual display 124 being formatted by the virtual graphics control circuitry as the user wishes them to appear on an actual display device of the type and configuration selected. Such formatting may comprise variables such as the range of colors able to be presented by a display device or the horizontal and vertical resolution and aspect ratio of the device. In this way the user may optimize the images sent to the virtual display to provide the correct level of color detail and aspect ratio to avoid distortion and blank areas at the top and bottom or sides of an image when the image is displayed during a presentation. The software causes the operating system to recognize the virtual graphics control circuitry and second display such that software operating on the device may send images to the virtual display 124.

An exemplary implementation of the virtual display software may be configured to create a display area (window) on the primary display within which a representation of images sent to the virtual second display may be shown 49. When the computer software completes the steps necessary to create a virtual second display, image capture software may be executed and thereby capture images from either the actual display or the simulated secondary display. When this image capture software is executed, an exemplary implementation of the virtual display software in conjunction with the image capture software will display the window 49 containing the representation of the virtual second display in the user interface of the image capture software 40. The image capture software, when instructed to start the capture process by the user, begins to monitor images that the computer operating system 20 has directed to the virtual graphics control circuitry 122 for display on the virtual second display device 124.

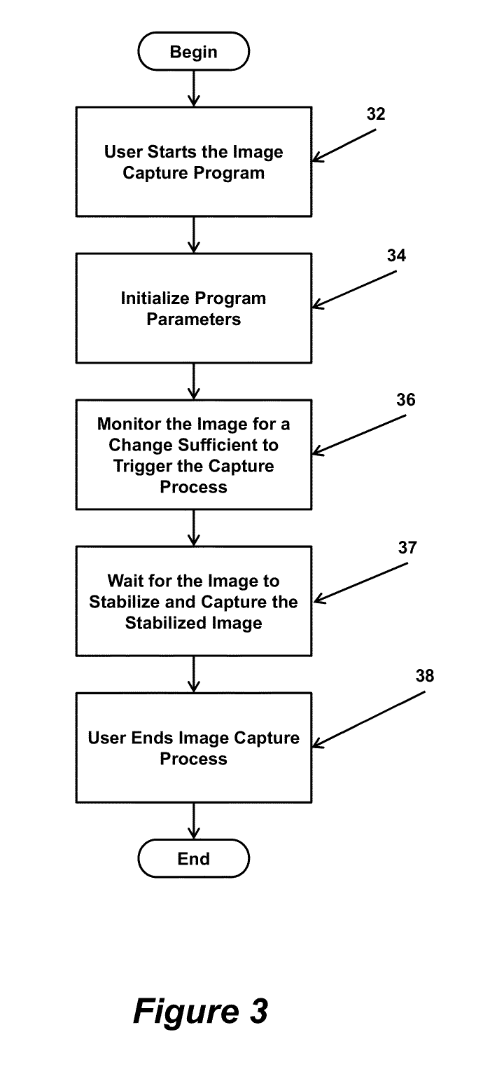

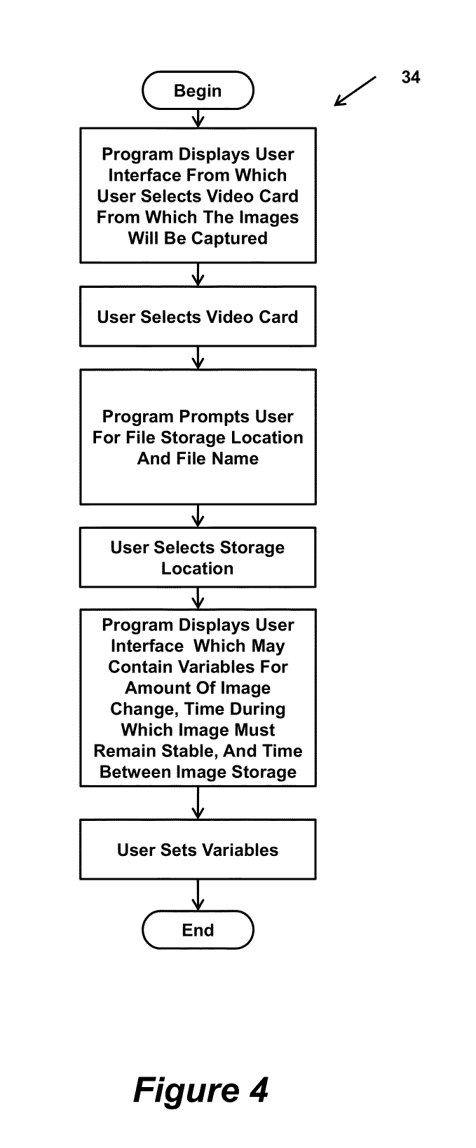

One purpose of the present invention is to enable presenters to prepare their presentations on a single computing device having a single monitor, to view the presentation, just as it would be viewed by a later audience. As it is being created by the software of the present invention, the presentation may be edited to include more or less images by adjustment of the parameters of the present invention, as the user sees fit. The virtual display mimics the display an audience would see of the presentation. In this manner the user of the invention is able to assemble a presentation from one device and view it on the same device prior to any formal presentation to an audience. In this age of handheld computing devices the advantages of the present invention to a presenter are, among other things, being able to see the outcome of a presentation on the same device from which it is created, while at the same time being able to make adjustments to content, by varying the parameters of image selection of the automated program of the present invention. Referring to FIG. 3, which is a flow diagram of an exemplary embodiment of the logic of the image capture algorithm which may be running on a personal computing device. When the user of the device wishes to capture images using software embodying the image capture and virtual graphics adapter algorithms, that user may select the software and cause the device to execute or run the software 32. Once the image capture software is running, the software may then initialize various parameters used to perform the image capture algorithm 34 and wait for an instruction or change to the image sufficient to trigger the capture and storage process 36. After such an instruction or triggering event, the software may wait for the image to stabilize before capturing the image 37. These steps of waiting for a triggering event and for the image to stabilize may be repeated until the user wishes to stop the process. When the user wishes to stop the capture and storage process, he or she may then instruct the software to stop the execution of the algorithm 38 and complete the storage process in such a manner as to make the collection of stored images ready for retrieval and later use. Referring to FIG. 4, the algorithm uses predetermined program parameters as may be set by the user to set the initial parameters for image capture. An exemplary embodiment of software implementing the algorithm may display a user interface with a control or other means for the user to start the image capture process or display a user interface which displays and may allow the user to adjust parameters used by the image capture algorithm.

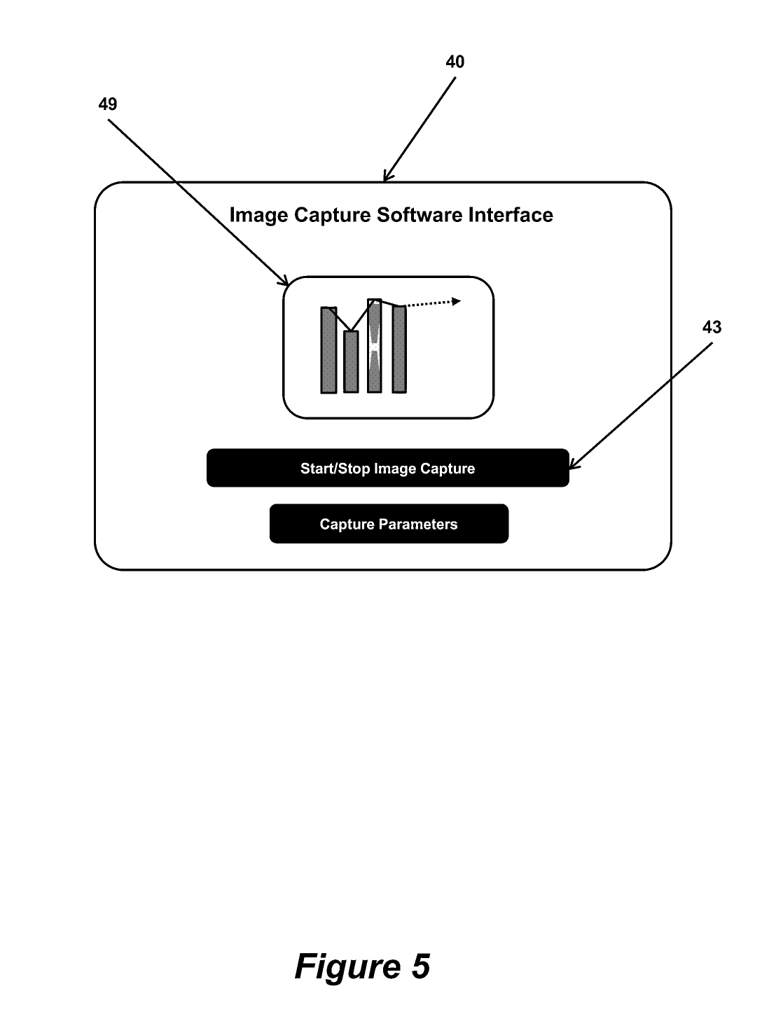

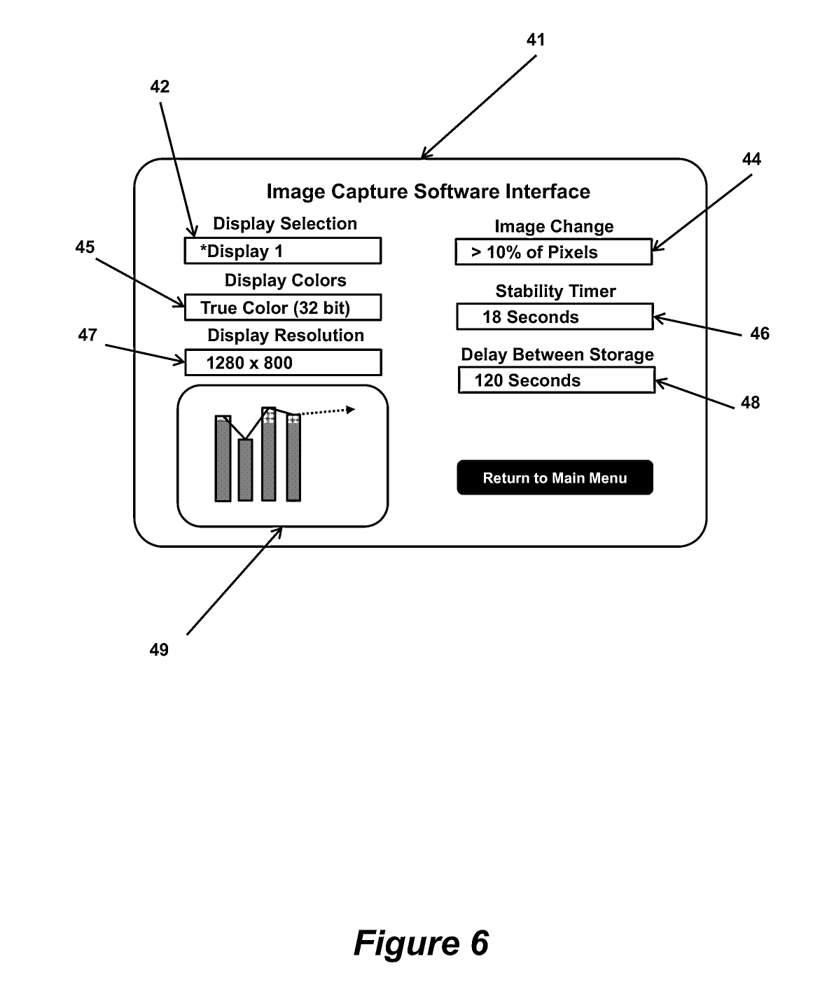

Referring to FIG. 5, a representative implementation of a main user interface 40 may display a start/stop control 43 and a view of captured images 49. Referring to FIG. 6, through a parameters user interface, a possible illustration of which is shown at 41, the software may then display available graphics control devices 42, which may include a virtual display device. When implemented with the virtual display software, the preferred embodiment of the invention will automatically select the virtual display device as the device from which images are captured and stored. The user may have the option to select a location in which to store the collection of images captured by the image capture algorithm. The user may select the number of colors supported 45, and the resolution and aspect ratio 47 used by the virtual graphics control circuitry when sending images to the virtual display. The computer software may also provide the user with the option of making adjustments to those parameters used by the image capture algorithm to select the initial changes required in an image to trigger the capture process 44, the amount of time that such an image remains relatively unchanged after an initial change before that image is stored 46, and the time that must elapse before the next image capture 48.

The three variables just discussed may be used in controlling the level of change detail captured by the algorithm and as a result, the number of images captured and stored. In a preferred embodiment of the invention, the user of the image capture algorithm may be able to adjust each variable separately to arrive at an optimal balance between the level of detail captured and the cumulative total size of the images captured and stored. The first variable, the amount of initial change to an image refers to the change that occurs to an image before the algorithm starts the capture process. This insures that the algorithm does not capture a series of images that are identical or nearly so. The user may determine how much change is desired between captures depending upon the type of material being captured and set this variable accordingly. The second variable, the amount of time that the image remains relatively unchanged after the initial change before the image is stored, serves to insure that the image is not in a state of change when it is stored. The purpose of this variable is to prevent as much as desired partially formed images from being captured and stored. The user may also determine, based upon the type of images being captured, how long an image is to remain unchanged before it is stored. The third variable is the amount of time that elapses between an image storage and the start of the next storage process. This variable is used to control the maximum number of images stored for a given time period and has the effect of determining the maximum storage capacity occupied by the series of captured and stored images.

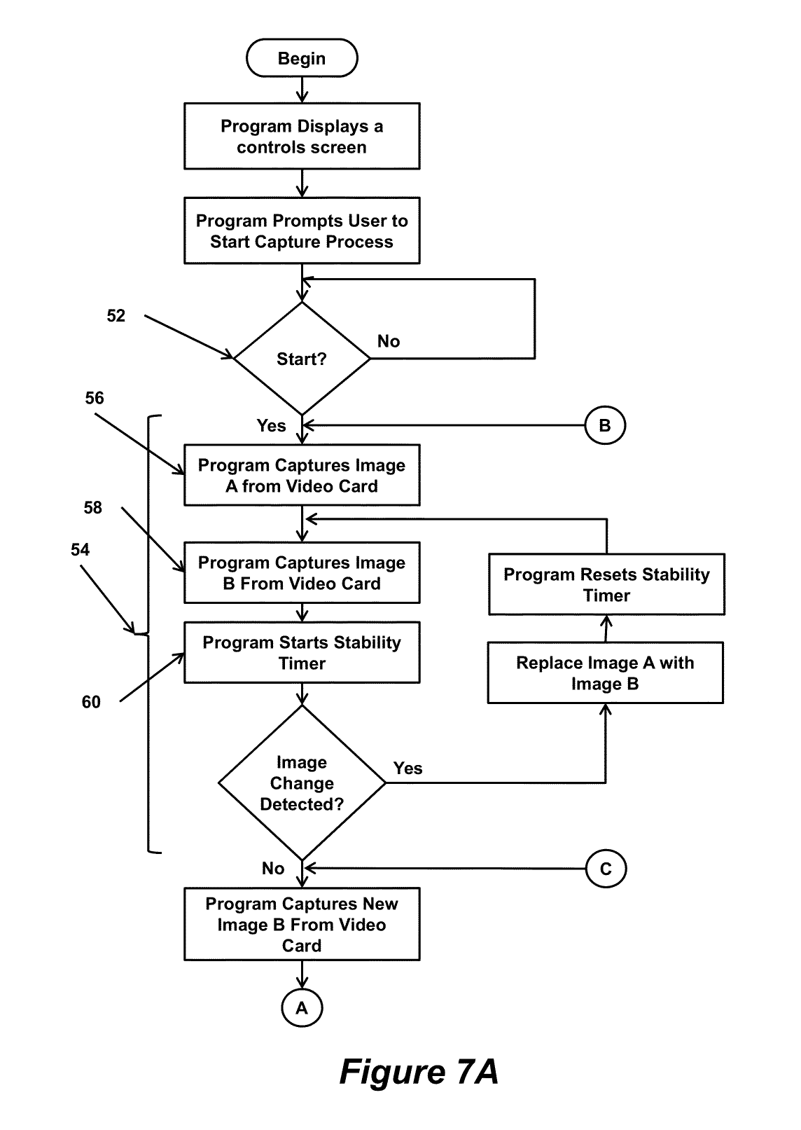

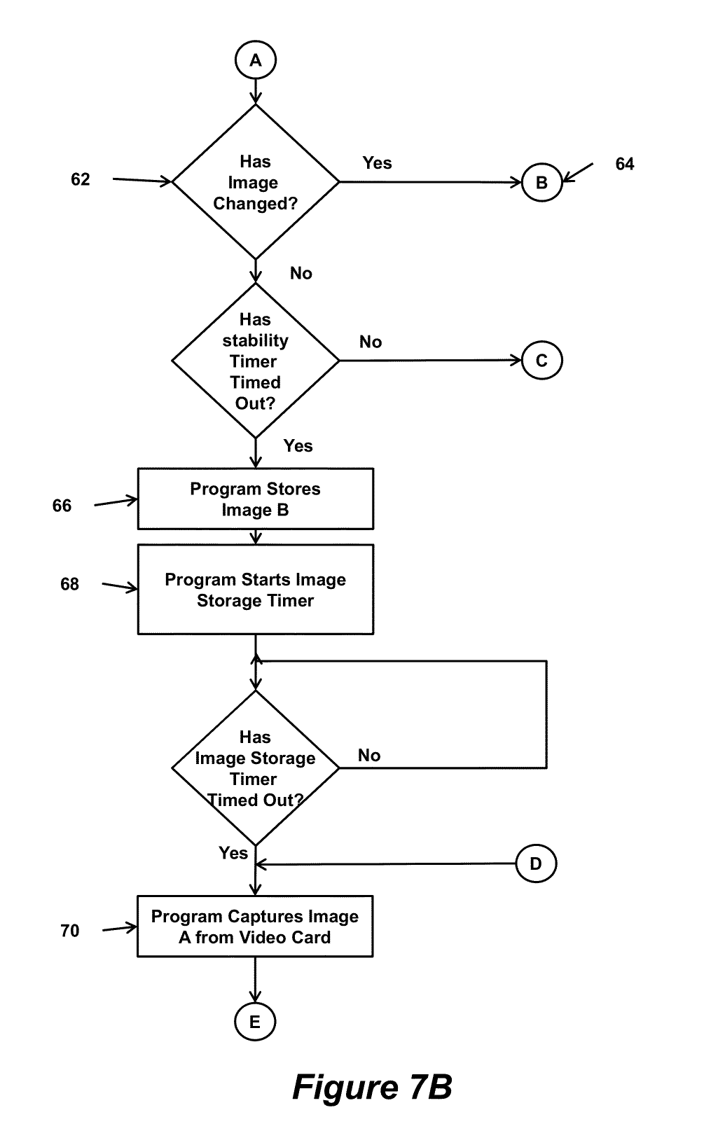

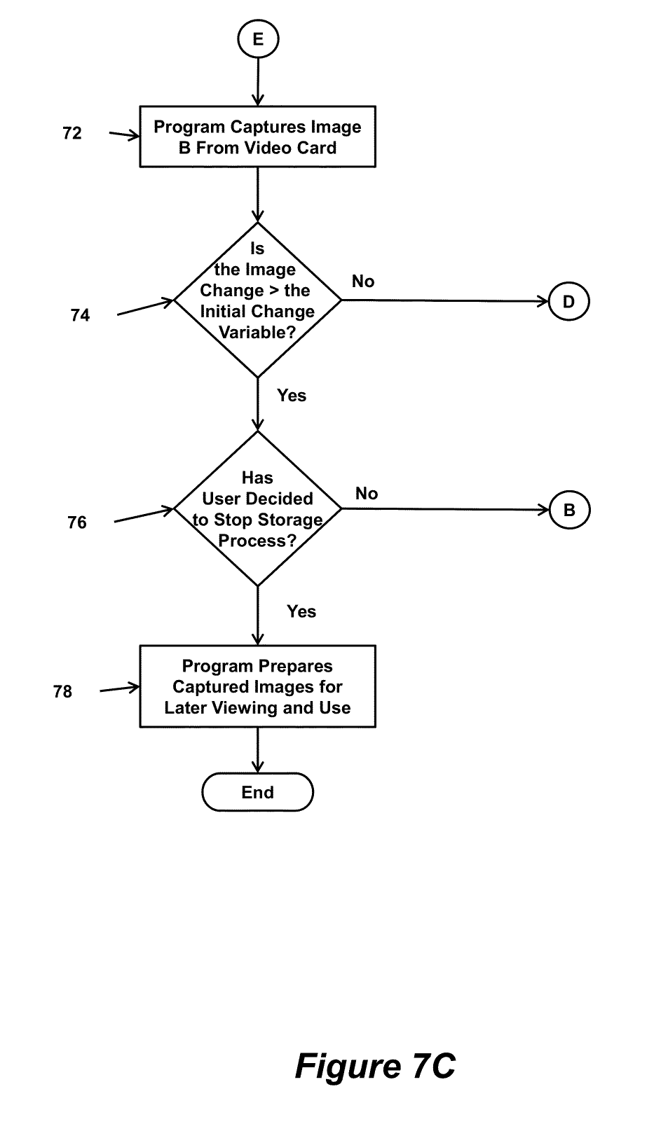

Referring to the flow diagram of FIGS. 7A-7C, when the user is satisfied with his selections, the computer software may then wait for the user to initiate the image capture process 52. This may be done by the selection of a control on the user interface but may also be done with a screen touch when the computing device is equipped with touch screen user interface or other such manner as the user finds convenient.

In order to optimize the number of images captured and stored, the invention waits for images to become stable before it captures and stores them 54. Because software implementing the image capture algorithm monitors changes to the image over time as part of its analysis process, this exemplary software implementation uses two images which will be referred to as Image A and Image B. When the user initiates the image capture process, the computer software captures an image from the graphics control circuitry and stores this image as Image A 56. The software may then capture a second image from the graphics control circuitry and store that image as Image B 58. The software then starts a timer used to determine if the image is stable (Stability Timer) 60.

When the computer software has acquired Image A and Image B, the program is run which compares Image B with Image A 62. The program determines if there has been a change between the two images that exceeds a predetermined amount. If such a change is detected, the algorithm may determine that the image is not stable and wait for it to stabilize before it is stored 64. If such a determination is made, the algorithm replaces Image A with Image B, resets the Stability Timer, and captures a new Image B. The algorithm then starts the Stability Timer. This process is repeated until there is not a change that exceeds the aforementioned predetermined amount from Image A to Image B.

When there is no change detected, in other words, the algorithm determines that the image remains stable from one comparison to the next, the algorithm continues to monitor the images for change until the Stability Timer reaches an amount of time that the user has selected (times out), meaning that the image is stable enough for capture and storage. If the image changes before the Stability Timer times out, the process starts anew 64. If the image is stable enough for storage, the algorithm stores Image B in the file location chosen by the user 66.

After an image is stored, the algorithm starts a second timer used to determine the amount of time between image storage (Image Storage Timer) 68. When this timer expires, the software captures a new Image A 70 and then a new Image B 72 and compares the two images to determine if there has been a change that exceeds the predetermined amount of initial change variable discussed above 74. If there has not been a change that exceeds this amount, a new Image B is captured and compared against Image A. This process continues until a change is detected that exceeds the amount specified by the initial change variable. When this occurs, the process of waiting for the image to stabilize 54.

This entire process; initial change detection, image stability monitoring, image storage, and time delay between storages, repeats until the user wishes to stop the image capture process 76. When the user wishes to stop the capture process, the software stops running the image capture algorithm and prepares the captured images 78 so that they may later be viewed and manipulated by the user as he or she sees fit.

In another embodiment of the invention, the user may run the image capture software as described above but the software has the additional capability of recording audio or audio/video files using hardware that may be connected to or otherwise available to the processor of the personal computing device. The capture software in this embodiment may encode information that identifies the capture times of each captured image such that the images can later be viewed in a manner that is synchronized with the audio or audio/video files recorded. An example of how this embodiment may be used would be to generate a presentation that not only includes a series of screen images but also an audio or audio/video recording of what is said or demonstrated along with each image.

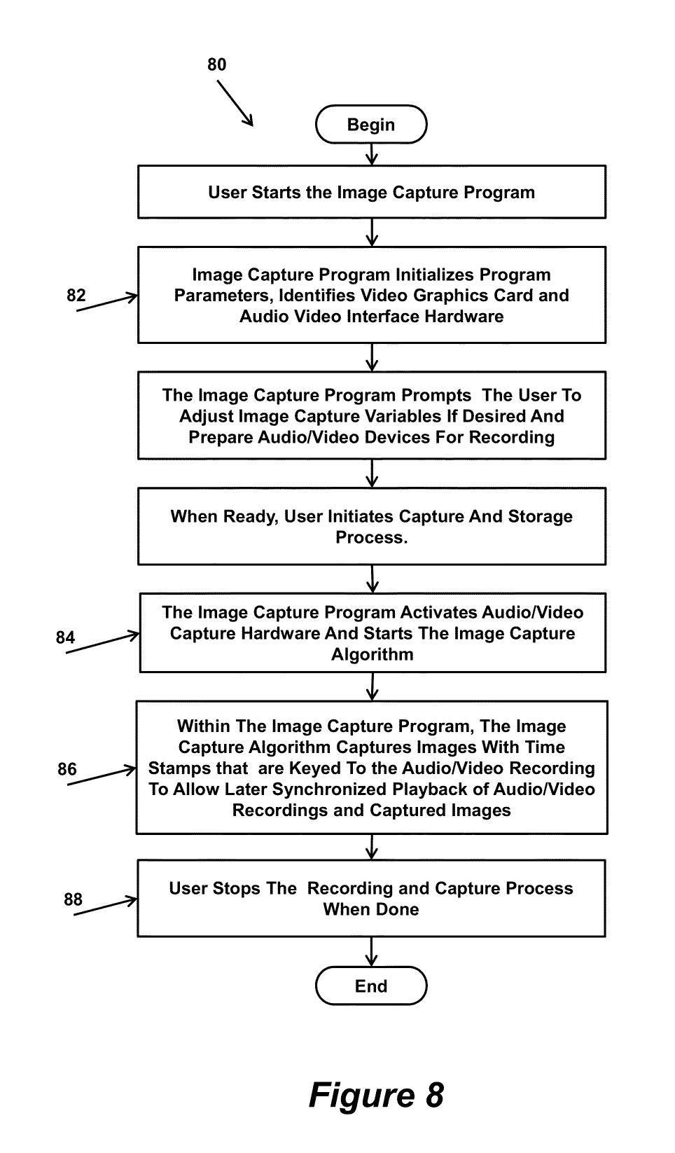

Referring to FIG. 8, a series of exemplary steps to accomplish this embodiment is shown in 80. The image capture software is started by the user. The software then initializes program parameters, including those variables used by the capture algorithm, and identifies the video graphics card or cards available for image capture 82. To enable the audio or audio/video capabilities, the software then identifies connected audio or audio/video capture circuitry depending upon which type of recording is to be captured. The image capture software displays a user interface and prompts the user to make any desired adjustments to the image capture variables and prepares the connected capture circuitry for recording.

When the user is ready to start the audio or audio/video recording and image capture process, the user may instruct the image capture software to start the capture process. When this instruction is given, the image capture software activates the audio or audio/video capture hardware and starts the image capture algorithm 84.

The image capture algorithm then runs in the same manner as previously detailed but with the additional step of adding time stamps to each captured image 86. These time stamps are keyed to the audio or audio/video file that is being recorded. These time stamps allow additional software to display the captured images in a manner that is synchronized to the playback of the audio or audio/video recording as may be the case.

When the user has completed the image capture and audio or audio/video recording, the user may instruct the image capture software to stop the image capture process 88. At this time, the software will also instruct the audio or audio/video recording hardware to stop recording and prepare the associated files for later use as desired.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for creating a virtual graphics control circuit and capturing and storing images from the virtual graphics control circuit comprising:
a computing device comprising a processor, an operating system, memory, a storage system, graphics control circuitry, and a display device;
a virtual graphics control circuit in the computing device adapted to simulate a second display device not actually connected to said computing device; and
an image capture program running on said computing device which monitors a stream of images directed from the computing device to said second display device and stores one or more individual images upon the satisfaction of predetermined capture conditions.

2. The system of claim 1, wherein:
said capture conditions comprise a change to the monitored images which exceeds a predetermined amount.

3. The system of claim 2, wherein:
said capture conditions further comprise, after said initial change, the monitored images remaining predominantly unchanged for a period of time.

4. The system of claim 2, wherein:
said capture conditions further comprise a predetermined period of time that elapses between each image storage.

5. The system of claim 1, further comprising:
an audio recording device connected to and in electronic communication with said computing device where an audio recording may be captured simultaneously with said storage of one or more images.

6. The system of claim 5, wherein:
said audio recording device further comprising the capability of recording a stream of video images is connected to and in electronic communication with said computing device where a video recording is captured simultaneously with said storage of one or more images.

7. A method of creating a virtual graphic control circuit and display device, comprising the steps of:
creating a virtual graphics circuit in the memory of the computing device of claim 1; and
communicating information comprising a signal to the operating system of the computing device of claim 1 which causes said operating system to act as if the virtual graphics control circuit and virtual display were actual devices connect to the computing device.

8. The method of claim 7, further comprising the steps of:
monitoring a stream of images present in the virtual graphics control circuit associated with said virtual display device; and
capturing and storing an image from such stream of images when an appreciable predetermined amount of change is detected in the image being monitored.

9. The method of claim 8, wherein:
said amount of change required before said image is captured is variable.

10. The method of claim 8, further comprising the step of:
waiting for an image to remain predominantly unchanged for a period of time before said image is captured and stored.

11. The method of claim 10, wherein:
said amount of time that an image remains predominantly unchanged prior to capture is variable.

12. The method of claim 8, further comprising the step of:
waiting for a predetermined period of time to elapse after capturing and storing of an image before the start of the capture and storage process for an additional image.

13. The method of claim 12, wherein:
said amount of time elapsing before the start of the next capture and storage steps is variable.

14. The method of claim 8, further comprising the step of:
displaying a user interface on the display device contained within the computer device of claim 1, which includes a representation of the last image captured and stored.

15. The method of claim 14, further comprising the step of:
displaying, in said user interface, variables which are adjustable to vary the parameters of said image capture method.

16. A method comprising the steps of:
capturing and storing images from the virtual graphics control circuit of the system of claim 1 when the following conditions are present:
an image has changed by a user selectable amount;
a user selectable period of time has passed since the last image was captured; and
the image is not currently undergoing appreciable substantial change.

17. A method comprising the steps of:
capturing and storing images from the virtual graphics control circuit of claim 5;
simultaneously capturing audio recordings from the audio recording device of claim 5; and
storing the images and audio recordings in a manner that permits the stored images to be displayed in synchronization with a replay of the audio recordings.

18. The method of claim 17, further comprising the steps of:
simultaneously capturing video recordings from the video recording device of claim 6; and
storing said images and video recordings to be stored in a storage device in such a manner that they may be replayed such that said stored images are displayed in synchronization with replay of the video recordings.
